(19) United States
(12) Patent Application Publication
(10) Pub. No.: US 2026/0307985 A1
(43) Pub. Date: Oct. 8, 2026

(54) REACTOR, SYSTEM AND PROCESS FOR CRACKING AMMONIA

(71) Applicant: Johnson Matthey Davy Technologies Limited, London (GB)

(72) Inventors: Vladimir DEMIDYUK, Billingham (GB); Peter Christopher HINDE, Billingham (GB); Kate MCFARLANE, Stockton-On-Tees (GB); John David PACH, Billingham (GB)

(21) Appl. No.: 19/483,883

(22) PCT Filed: Jul. 11, 2024
(86) PCT No.: PCT/GB2024/051807

§ 371 Date: Nov. 12, 2025

(30) Foreign Application Priority Data
Jul. 12, 2023 (GB) 2310698.2

(51) Int. Cl. C01B 3/047

(52) U.S. Cl. CPC C01B 3/047; C01B 2203/0277; C01B 2203/0811; C01B 2203/085; C01B 2203/1017; C01B 2203/1205

(57) ABSTRACT

An ammonia cracking reactor including one or more reaction tubes containing ammonia cracking catalyst; one or more fuel combustion elements for combusting fuel in a fuel combustion zone surrounding the one or more reaction tubes to provide heat energy to support the cracking of ammonia in the one or more reaction tubes; and one or more electrically powered heating elements to provide heat energy to support the cracking of ammonia in the one or more reaction tubes, wherein the one or more fuel combustion elements and the one or more electrically powered heating elements are provided in the same reactor for supporting the cracking of ammonia in the same reaction tubes and together form an electrically assisted fuel burning ammonia cracking reactor.

### FIELD

The present specification relates to a reactor, a system, and a process for producing hydrogen gas by catalytically cracking ammonia.

### BACKGROUND

There is renewed interest in using hydrogen as a green, carbon free, fuel in a variety of industrial settings. Hydrogen may be combusted to produce heat energy or electricity. Alternatively, hydrogen may be used to produce electrochemical energy in, for example, a fuel cell.

Ammonia has received interest as a possible compound to enable the storage and transport of hydrogen. Liquid ammonia has a higher hydrogen density than liquid hydrogen and may be transported using existing infrastructure which is already in use for this purpose, such as that used for the transportation of ammonia in the agrochemical fertiliser industry. Once the liquid ammonia has been transported it may be combusted directly or converted to hydrogen by the process of cracking.

The catalytic cracking of ammonia into hydrogen and nitrogen has been known for many years. The reaction may be depicted as follows:

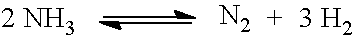

The ammonia cracking reaction is endothermic and may usefully be achieved by passing ammonia over a suitable catalyst in heated catalyst-containing reaction tubes disposed in a furnace. Such furnaces are known, for example, for the steam reforming of natural gas or naphtha feedstocks. In industrial processes used for the catalytic cracking of ammonia, the gas produced by the ammonia cracking reaction is purified to produce a purified hydrogen stream and a waste gas stream.

There remains a need for improved processes for the catalytic cracking of ammonia.

### SUMMARY

One issue to consider is how to most effectively heat the cracking reactor to support the endothermic ammonia cracking reaction. One option is to combust a waste gas stream from the ammonia cracking system, which comprises residual hydrogen, residual ammonia, and nitrogen. However, there is not sufficient energy from waste gas burning to achieve the desirable reaction temperature.

It has been suggested that the shortfall in energy from combustion of the waste gas stream can be met by the addition of natural gas, ammonia, cracked gas, hydrogen or a mixture of these gases to the waste gas for combustion. However, each of these approaches has disadvantages. Combustion of ammonia gas, cracked gas, and/or produced hydrogen reduces the amount of hydrogen product gas which can be produced from the ammonia gas input to the system. Combustion of natural gas is not preferred from an environmental fossil fuel use or CO₂ production perspective.

In contrast to the above, the present specification proposes covering the shortfall in energy from combusting the waste off-gas with electrical energy. As such, the present specification provides an ammonia cracking reactor comprising:
one or more reaction tubes containing ammonia cracking catalyst;
one or more fuel combustion elements for combusting fuel in a fuel combustion zone surrounding the one or more reaction tubes to provide heat energy to support the cracking of ammonia in the one or more reaction tubes; and
one or more electrically powered heating elements to provide heat energy to support the cracking of ammonia in the one or more reaction tubes,
wherein the one or more fuel combustion elements and the one or more electrically powered heating elements are provided in the same reactor for supporting the cracking of ammonia in the same reaction tubes and together form an electrically assisted fuel burning ammonia cracking reactor.

The electrically powered heating elements are not limited to resistive heating and include other means of electrically powered heating, e.g., induction, plasma, etc.

The present specification is thus concerned with electrifying a fuel combustion type ammonia cracking reactor. The combination of electrified heating with burning of the waste off-gas is used here to reduce the electrical load when compared to an electrical-only system while recovering heating value from the waste gas and safely disposing of the waste gas. This technology enables decarbonisation of the ammonia cracking process and reduced energy consumption via the combination of electrified heating with burning the waste off-gas. The electrical heating can be applied in different forms including thermal plasma, non-thermal plasma, induction heating, and resistive heating. Waste gas containing up to 40% of hydrogen is safely utilised in this process. The hydrogen content of the waste gas will depend on the hydrogen purifier (e.g., pressure swing adsorption unit) and the amount of hydrogen in the purifier tail gas which is directed for use as fuel in the ammonia cracking reactor.

The electrification of the ammonia cracking reactor enables the use of electricity to achieve the desirable catalyst temperature in the combination with burning of waste offgas. This removes the need for a top-up fuel (potentially either the ammonia feed, or the cracked gas or hydrogen product), improving the hydrogen efficiency/recovery of the process. Furthermore, the combustion of fuels generates emissions such as NOₓ and N₂O. Replacing some of the combustion duty with electrical heating can reduce these emissions and therefore the environmental impact of the process.

It should be noted that electrically heated reactors are known as an alternative to fuel gas combustion reactors. However, in accordance with the present specification electrical and gas combustion heating are combined in a single ammonia cracking reactor configuration where the electrical energy is provided to make up for a shortfall in the energy provided by combustion of fuel gas within the reactor and can enable, for example, the combustion process to be mainly or fully fuelled by waste gas from the ammonia cracking system. Furthermore, this single combined reactor solution can be cheaper than two separate reactors, one electrically heated and the other heated by combustion.

The electrification of a fuel burning reactor can be achieved by various different methods as described in more detail below. The present specification also provides a system and process for cracking ammonia using the electrified, fuel burning ammonia cracking reactor.

### BRIEF DESCRIPTION OF THE DRAWINGS

For a better understanding of the present invention and to show how the same may be carried into effect, certain embodiments of the present invention will now be described by way of example only with reference to the accompanying drawings, in which:

FIG. 1 shows a schematic diagram of an ammonia cracking reactor based on fuel burning;

FIG. 2 shows a schematic diagram of an electrically assisted fuel burning ammonia cracking reactor with electrically powered heating elements within the combustion zone along with gas burners;

FIG. 3 shows a schematic diagram of an electrically assisted fuel burning ammonia cracking reactor with electrically powered heating elements within the reaction tubes and gas burners external to the reaction tubes in the combustion zone;

FIG. 4 shows a schematic diagram of an electrically assisted fuel burning ammonia cracking reactor with plasma torches in place of conventional gas burners;

FIG. 5 shows a schematic diagram of an electrically assisted fuel burning ammonia cracking reactor with electrically heated, catalyst assisted combustion of waste gas in the combustion zone;

FIG. 6 shows a schematic diagram of an electrically assisted fuel burning ammonia cracking reactor with a single arrangement for cracking and combustion catalysts;

FIG. 7 shows a schematic diagram of an electrically assisted fuel burning ammonia cracking reactor comprising electrified heating elements within the reaction tubes combined with hydrogen combustion catalysts round the outside of the reaction tubes; and

FIG. 8 shows a schematic diagram of an electrical connection for the electrically assisted fuel burning ammonia cracking reactor comprising electrified heating elements within the reaction tubes combined with hydrogen combustion catalysts round the outside of the reaction tubes.

In all figures, like reference numerals are used for like parts. A list of the references is provided below:

### REFERENCE ITEM

2 Ammonia Cracking Reactor
4 NH₃ Gas
6 Catalyst Containing Reaction Tubes
8 Cracked Gas
10 Fuel
12 Gas Burners
14 Combustion Zone
16 Flue Gas Duct Heat Recovery (e.g., steam generation, superheating, or process heating)
18 Electrical Heater (in combustion zone)
20 Purifier (e.g., Pressure Swing Adsorption Unit)
22 Purified Hydrogen Gas Stream
24 Waste Gas Stream (e.g., off-gas waste <20% H₂)
26 Electrical Heater (in reaction tubes)
28 Catalyst coated electrically heated elements (e.g., from Catacel)
30 Plasma Torches
32 Plasma Torch Electrodes
34 Plasma Plume
36 Combustion Catalyst
38 Electrical Heater Thermally Coupled with Combustion Catalyst
40 Metal electrode of heating elements
42 Ceramic support
44 Solder
46 Electrical isolators
48 Leak detector (e.g., ammonia sensor or pressure gauge)

### DETAILED DESCRIPTION

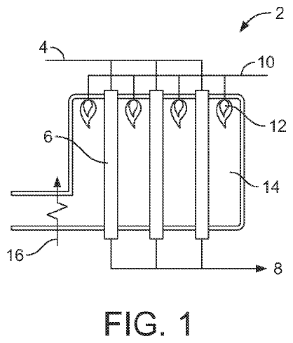

FIG. 1 shows an example of a fired ammonia cracking reactor 2. Fired ammonia cracking reactors 2 are known and may comprise a fuel combustion zone 14 having a radiant section comprising one or more burners 12 to which one or more fuel streams 10 and an oxidant-containing feed gas, such as air, oxygen enriched air, or oxygen, are fed. The radiant section may comprise one or more catalyst containing reaction tubes 6 through which the ammonia stream 4 is passed and cracked to produce a hydrogen containing cracked gas stream 8. Combustion of one or more fuel streams 10 in the one or more burners 12 of the fuel combustion zone, creates heat energy (e.g., radiant heat) for heating the one or more catalyst containing reaction tubes 6. There may be tens or hundreds of catalyst containing reaction tubes 6 in the radiant section. If desired, downstream of the radiant section, a flue gas from the combustion of the one or more fuel streams may be used to pre-heat one or more feed streams in a convection section 16. Reactors comprising a radiant section containing catalyst containing reaction tubes and a convection section for preheating feeds are known in steam methane reforming and may be applied to the present invention.

In accordance with the present specification, an ammonia cracking reactor configuration such as that illustrated in FIG. 1 is modified to include electrical heating in combination with fuel gas combustion heating. In this regard, it should be noted that electrically heated reactors are known as an alternative to fuel gas combustion reactors. However, in accordance with the present specification electrical and gas combustion heating are combined in a single ammonia cracking reactor configuration where the electrical energy is provided to make up for a shortfall in the energy provided by combustion of fuel gas within the reactor and can enable, for example, the combustion process to be mainly or fully fuelled by waste gas from the system.

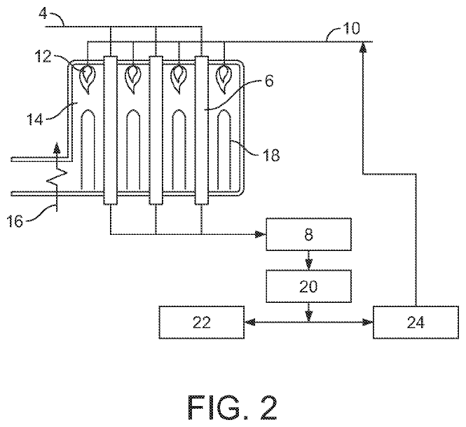

FIG. 2 shows a schematic diagram of an electrically assisted fuel burning ammonia cracking reactor with electrically powered heating elements within the combustion zone along with gas burners. In many respects the ammonia cracking reactor is similar to that shown in FIG. 1. Ammonia input gas 4 is provided into reaction tubes 6 which have ammonia cracking catalyst disposed therein to crack the ammonia and produce a hydrogen containing cracked gas 8. Fuel gas 10 is provided to burners 12 for combustion of the fuel gas in a combustion zone 14 surrounding the reaction tubes 6. Flue gas from the combustion may be used to pre-heat one or more feed streams 16.

A key difference between the configurations of FIGS. 1 and 2 is that in the configuration of FIG. 2 comprises one or more electrically powered heating elements 18 for providing additional heat to the reaction tubes. In the configuration of FIG. 2, the electrically powered heating elements 18 are provided within the combustion zone surrounding the reaction tubes. One advantage of this configuration is that less heat energy is required from the burners to reach the desired reaction temperature in the reaction tubes. As such, this can enable the burners to be completely, or at least mainly, fuelled by waste gas from the system without the need for a large amount of additional fuel. As shown in FIG. 2, the cracked gas 8 can be passed to a purifier 20 such as a pressure swing adsorption unit. The purifier 20 generates a purified hydrogen gas stream 22 and a waste gas stream 24 which comprises a mixture of nitrogen and residual ammonia and nitrogen (e.g., off-gas waste <20% H₂). The waste gas 24 can be recycled and used as fuel 10 for combustion in the combustion zone of the reactor. As heating of the reaction tubes 6 is complemented by the electrical heating elements 18, this enables a majority (e.g., at least 50%, 60%, 70%, 80%, 90%, 95%, or 100%) of the fuel combusted by the burners 12 to be provided by the recycled waste gas 24.

It should be noted that while FIG. 2 shows a top-fired reactor with electrical heating elements (i.e., a reactor where the burners 12 are at the top of the reactor) it will be appreciated that other burner configurations are possible such as a bottom or side-fired reactor.

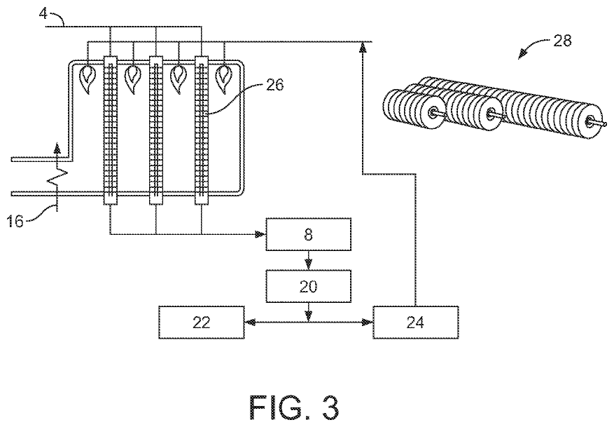

FIG. 3 shows a schematic diagram of another electrically assisted fuel burning ammonia cracking reactor with electrically powered heating elements within the reaction tubes and gas burners external to the reaction tubes in the combustion zone. This arrangement is similar to that shown in FIG. 2 and the common features are not repeated here for conciseness. The main difference here is that the electrically powered heating elements 26 are within the reaction tubes rather than in the combustion zone. The electrically powered heating elements 26 can be in the form of catalyst coated components 28 as pictured in FIG. 3. This configuration can reduce electrical load due to the fact that electrical heating is provided directly to the catalyst components.

In the configurations shown in FIGS. 2 and 3, one or more of the electrically powered heating elements are provided within the fuel combustion zone and/or within the one or more reaction tubes. The electrically powered heating elements can provide heat energy to support the cracking of ammonia in the one or more reaction tubes (e.g., via resistive heating) rather than driving combustion of the fuel. In contrast, it is also possible to provide one or more electrically powered heating elements which are integrated with one or more of the fuel combustion elements such that the one or more electrically powered heating elements drive the combustion of the fuel as discussed below.

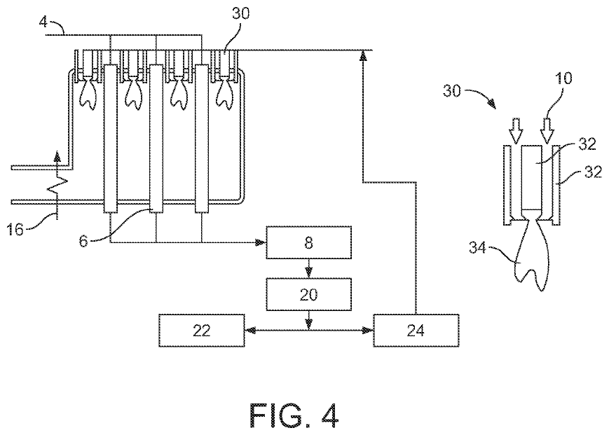

FIG. 4 shows a schematic diagram of another electrically assisted fuel burning ammonia cracking reactor with plasma torches 30 in place of conventional gas burners. In this case, rather than having separate fuel gas burners and resistive electrical heating elements, the fuel burner and electrically powered elements are integrated into a plasma torch 30. As shown in FIG. 4, the plasma torches have a fuel gas inlet 10 and electrodes 32 to produce a plasma plume 34. It should be noted that in this plasma torch configuration, the gas provided to the fuel gas inlet does not need to be a typical combustible fuel and could be, for example, air, off-gas, or some other gas suitable for forming the plasma plume 34. Waste off gas can be added before or after the plasma plume. The latter method may be more preferable due to lower NOₓ formation. In other respects, the configuration is similar to those which have previously been described and the common features are not repeated here for conciseness.

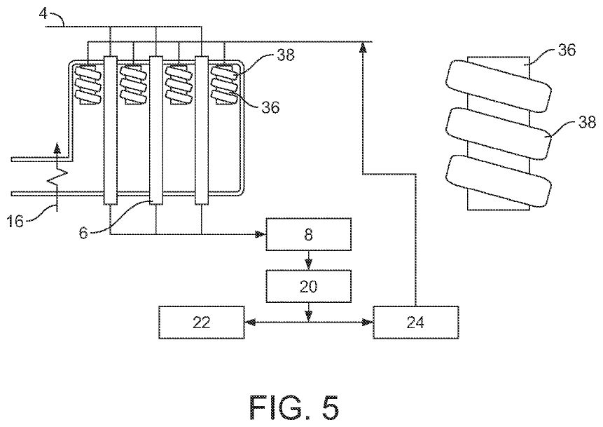

FIG. 5 shows a schematic diagram of another electrically assisted fuel burning ammonia cracking reactor with electrically heated, catalyst assisted combustion of waste gas in the combustion zone. In this case, gas burners can be replaced with an oxidative combustion catalyst 36 and electrical heaters 38 to drive combustion of fuel gas in the combustion zone. At start up, the oxidative catalyst can be heated, e.g., up to 700° C., with electricity. This temperature is sufficient for ammonia and hydrogen to be oxidised without formation of a significant amount of NOx. The shortfall in energy from combusting the waste off-gas can be covered by the electrical heaters during the normal operation of the ammonia cracking reactor.

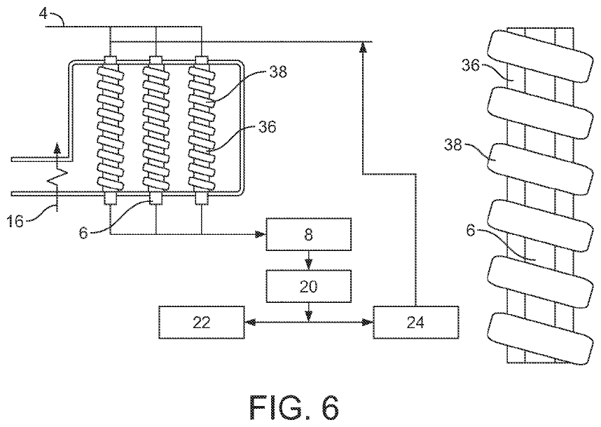

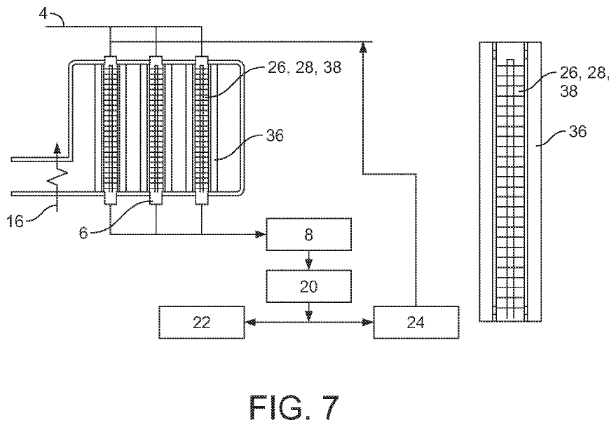

In FIG. 5, the combustion catalyst 36 and electrical heater elements 38 are disposed at fuel gas inlets of the combustion zone. In contrast, in the configuration of FIG. 6 the combustion catalyst 36 and electrical heater elements 38 are disposed around the outside of the reaction tubes 6. In this case both the cracking and combustion catalysts can be arranged in a single unit when the electrically heated oxidative catalyst is placed around the ammonia cracking catalyst. In yet another configuration as shown in FIG. 7, the electrical heating elements 26, 28, 38 are ammonia cracking catalyst coated elements disposed within the reaction tubes 6 in a similar manner to the configuration of FIG. 3 with combustion catalyst 36 disposed around the reaction tubes. Again, in other respects the configurations of FIGS. 5 to 7 are similar to those which have previously been described and the common features are not repeated here for conciseness. Additionally, it is possible to modify embodiments shown in FIGS. 3 and 7 to replace an electrified CATACEL™ style ammonia cracking catalyst with a catalyst coated on conductive structured ceramic supports. Doped ceramics such as silicon carbide, molybdenum disilicide, lanthanum chromite, zirconium oxide, silicon nitride and other conductive material can be used as a catalyst support in this case.

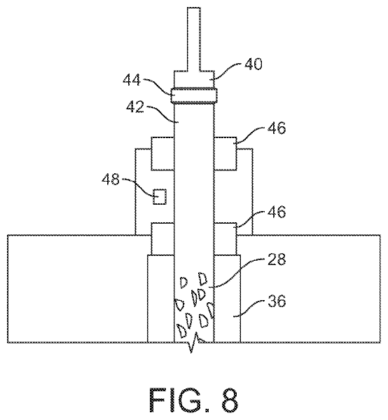

FIG. 8 shows an electrical connection configuration for an electrically assisted fuel burning ammonia cracking reactor comprising electrified heating element(s) 40, 42, 44 within the reaction tube(s) combined with hydrogen combustion catalysts 36 round the outside of the reaction tube(s). The electrified heating elements comprise a metal electrode 40 connected to a conductive ceramic support 42 via a weld/joint/solder material 44. In order to avoid the formation of contact resistance between metal and ceramic materials it is desirable to weld the metal electrode 40 of the heating element to the conductive ceramic support 42 with solder 44. The metal-ceramic joint can be placed inside of the reaction zone of the reactor or outside of this zone. The latter option helps to reduce/avoid the generation of thermal stresses between joint materials and eliminates possible chemical reaction between the solder (or other weld/joint material) and gas mixture. However, in this case the ceramic support may have two parts-a non-porous segment connected to the metal electrode 40 of the heating element(s) and a porous segment coated with ammonia cracking catalyst 28. Electrical isolators 46 graded for high pressure operation (e.g., spark plug ceramic) can be used to isolate electricity provided to the inside of the pressurised reactor via the electrified heating elements 40, 42, 44. From a safety viewpoint, the additional chamber illustrated in FIG. 8 with, for example, ammonia sensor or pressure gauge 48, can be installed to indicate any possible leak from the pressurised reactor.

In light of the above, it will be appreciated that the electrification of a fuel burning ammonia cracking reactor can be achieved by various different methods:
One or more electrically heated elements can be included in the ammonia cracking reactor within the combustion zone (FIG. 2).
One or more electrically heated elements can be included in the ammonia cracking reactor within the one or more reaction tubes, e.g., electrical elements can be coated with ammonia cracking catalyst and disposed within the reaction tubes (FIG. 3).
Gas burners can be replaced with electrically driven plasma torches in the combustion zone (FIG. 4).
Gas burners can be replaced with an oxidative combustion catalyst and electrical heaters to drive combustion of fuel gas. The electrical heaters and combustion catalyst can be arranged in several different configurations including:
   Combustion catalyst and electrical heater elements disposed at fuel gas inlets of the combustion zone (FIG. 5).
   Combustion catalyst and electrical heater elements disposed around the outside of the reaction tubes (FIG. 6).
   Electrical heater elements within the reaction tubes and combustion catalyst disposed around the outside of the reaction tubes (FIG. 7).

In all these configurations, the ammonia cracking reactor comprises one or more reaction tubes containing ammonia cracking catalyst, one or more fuel combustion elements for combusting fuel in a fuel combustion zone surrounding the one or more reaction tubes to provide heat energy to support the cracking of ammonia in the one or more reaction tubes, and one or more electrically powered heating elements to provide heat energy to support the cracking of ammonia in the one or more reaction tubes. The electrically powered heating elements can be provided as separate elements to the fuel combustion elements for providing additional heat energy to support the cracking of ammonia in the one or more reaction tubes. Alternatively, the electrically powered heating elements can be integrated with the fuel combustion elements such that the electrically powered heating elements drive the combustion of the fuel to support the cracking of ammonia in the one or more reaction tubes.

The electrically powered heating elements can reduce fuel consumption and, for example, enable waste gas from the system to be used as the predominant or only fuel source for the fuel combustion elements. Furthermore, configurations as described herein can additionally or alternatively enable greater flexibility in the type of fuel which can be utilized. This can be particularly useful when starting up an ammonia cracking reactor when hydrogen containing waste or product gas is not yet available for combustion as fuel for the cracking reactor. In this case, it would be advantageous to be able to utilize the ammonia source gas to fuel the cracking reactor, at least during start-up of the system when only ammonia may be available as a fuel. Experimental work has shown that the burners in a standard fired ammonia cracker reactor will not light off (i.e., a flame will not be formed) when using 100% ammonia fuel. In contrast, the present specification enables the use of electrically powered heating elements to ignite ammonia fuel for ammonia cracker start up. As such, configurations according to the present specification can provide advantages in terms of starting up the ammonia cracking reactor system as well as advantages in terms of the long-term operation of the ammonia cracking reactor system including reduced fuel consumption, reduced emissions, and/or reduced operating costs.

The ammonia cracking catalyst in the catalyst containing reaction tubes may be any ammonia cracking catalyst. For instance, nickel catalysts and/or ruthenium catalysts may be used. Preferred catalysts are nickel catalysts. The catalyst may comprise 3 to 30% by weight nickel, preferably 8 to 20% by weight nickel, expressed as NiO, on a suitable refractory support, such as alumina or a metal aluminate. The catalyst may be in the form of pelleted shaped units, which may comprise one or more through holes, or may be provided as a wash coat on a structured metal or ceramic catalyst. A particularly preferred catalyst is KATALCO® 27-200MQ available from Johnson Matthey PLC, which comprises 16 wt % nickel, expressed as NiO, on a cylindrical pellet formed from a high surface area calcium aluminate support.

The input ammonia stream may be heated prior to being supplied to the electrified fired ammonia cracking reactor. Accordingly, the process of the invention may comprise the step of heating the input ammonia stream. The input ammonia stream may be heated to a temperature of greater than 350° C., greater than 400° C., greater than 450° C., greater than 500° C., or greater than 550° C. The input ammonia stream may be heated to a temperature of less than 1000° C., less than 950° C., less than 850° C., less than 750° C., or less than 700° C. The input ammonia stream may be heated to a temperature of from 350° C. to 1000° C., from 400° C. to 950° C., from 450° C. to 850° C., or from 500° C. to 750° C., such as from 550° C. to 700° C.

The temperature of the hydrogen containing stream exiting the one or more catalyst containing reaction tubes will influence the equilibrium position of the cracking reaction, and may be in the range of 500 to 950° C. Where nickel catalysts are used in the one or more catalyst containing reaction tubes, the temperature of the hydrogen containing stream exiting the one or more catalyst containing reaction tubes may preferably be greater than about 700° C.

The pressure inlet to the one or more catalyst containing reaction tubes will be set by the flowsheet design and may be in the range 1 to 100 bar absolute, preferably 10 to 90 bar absolute, such as 31 to 51 bar absolute.

The hydrogen containing stream from the reactor can be fed to one or more purification units to increase the hydrogen content of the hydrogen containing stream to produce an enriched hydrogen stream and a tail gas stream. An example of a purification unit is a pressure swing adsorption unit, to increase the H₂ content by separating H₂ from the other components. The tail gas stream can be recycled and combusted as fuel in the combustion zone of the main reactor.

It may be preferred that prior to feeding the hydrogen containing stream to the one or more purification units that the hydrogen containing streams are fed to a steam generation unit and/or a heat recovery zone. As will be understood by the skilled person the steam generation unit and/or the heat recovery zone may be used to recover low or medium grade heat.

The enriched hydrogen stream after purification may comprise 70 mol % or more H₂, 75 mol % or more H₂, 80 mol % or more H₂, 85 mol % H₂ or more, or 90 mol % H₂ or more. The enriched hydrogen stream may comprise up to 100 mol % or less H₂. For example, the enriched hydrogen stream may comprise from 70 mol % to 100 mol % H₂, from 75 mol % to 100 mol % H₂, from 80 mol % to 100 mol % H₂, from 85 mol % to 100 mol % H₂, or from 90 mol % to 100 mol % H₂. Preferably, the enriched hydrogen stream may comprise greater than 90 mol % H₂, greater than 95 mol % H₂, greater than 98 mol % H₂, or greater than 99 mol % H₂. More preferably, the enriched hydrogen stream may comprise greater than 99.9% mol % H₂, greater than 99.95 mol % H₂, or about 100 mol % H₂. Most preferably, the enriched hydrogen containing stream may comprise greater than 99.95 mol % H₂ or about 100 mol % H₂.

While this invention has been particularly shown and described with reference to certain examples, it will be understood to those skilled in the art that various changes in form and detail may be made without departing from the scope of the invention as defined by the appended claims.

1. An ammonia cracking reactor comprising:
one or more reaction tubes containing ammonia cracking catalyst;
one or more fuel combustion elements for combusting fuel in a fuel combustion zone surrounding the one or more reaction tubes to provide heat energy to support the cracking of ammonia in the one or more reaction tubes; and
one or more electrically powered heating elements to provide heat energy to support the cracking of ammonia in the one or more reaction tubes, wherein the one or more fuel combustion elements and the one or more electrically powered heating elements are provided in the same reactor for supporting the cracking of ammonia in the same reaction tubes and together form an electrically assisted fuel burning ammonia cracking reactor.

2. An ammonia cracking reactor according to claim 1, wherein one or more of the electrically powered heating elements are provided within the fuel combustion zone.

3. An ammonia cracking reactor according to claim 1, wherein one or more of the electrically powered heating elements are provided within the one or more reaction tubes.

4. An ammonia cracking reactor according to claim 1, wherein one or more of the electrically powered heating elements provide heat energy to support the cracking of ammonia in the one or more reaction tubes via resistive heating rather than driving combustion of the fuel.

5. An ammonia cracking reactor according to claim 3, wherein the electrically powered heating elements are coated with the ammonia cracking catalyst within the one or more reaction tubes.

6. An ammonia cracking reactor according to claim 1, wherein one or more of the electrically powered heating elements are integrated with one or more of the fuel combustion elements such that the one or more electrically powered heating elements drive the combustion of the fuel.

7. An ammonia cracking reactor according to claim 6, wherein one or more of the electrically powered heating elements are integrated with one or more of the fuel combustion elements as one or more plasma torches comprising electrically powered electrodes.

8. An ammonia cracking reactor according to claim 6, wherein one or more of the electrically powered heating elements are integrated with one or more of the fuel combustion elements as one or more electrically heated elements and one or more combustion catalyst elements to drive the combustion of the fuel via electrically heated catalyst assisted combustion of the fuel.

9. An ammonia cracking reactor according to claim 8, wherein the or each electrically heated element is disposed over or around the or each combustion catalyst element.

10. An ammonia cracking reactor according to claim 8, wherein the or each electrically heated element and the or each combustion catalyst element are disposed around the outside of the one or more reaction tubes containing the ammonia cracking catalyst.

11. An ammonia cracking reactor according to claim 8, wherein the or each electrically heated element is disposed in the one or more reaction tubes containing the ammonia cracking catalyst and the or each combustion catalyst element is disposed around the outside of the one or more reaction tubes.

12. A system for the catalytic cracking of ammonia to produce hydrogen, the system comprising:
an ammonia cracking reactor according to any preceding claim to crack an ammonia gas input stream using a combination of electrical and combustion energy to generate a hydrogen containing gas stream; and
a purification unit to increase the hydrogen content of the hydrogen containing gas stream.

13. A system according to claim 12, wherein the purification unit is configured to generate a purified hydrogen gas stream and a waste gas stream, and wherein the system is configured to direct the waste gas stream from the purification unit to the combustion zone of the ammonia cracking reactor to at least partially fuel the ammonia cracking reactor.

14. A process for cracking ammonia using the system according to claim 12, the process comprising:
feeding an ammonia gas input stream to the ammonia cracking reactor to crack the ammonia gas input stream using a combination of electrical and combustion energy to generate a hydrogen containing gas stream; and
purifying the hydrogen containing gas stream to increase the hydrogen content of the hydrogen containing gas stream.

15. A process according to claim 14, wherein the purification unit generates a purified hydrogen gas stream and a waste gas stream, and the waste gas stream from the purification unit is directed to the combustion zone of the ammonia cracking reactor to at least partially fuel the main ammonia cracking reactor.

16. A process according to claim 14, wherein the system is started by supplying ammonia fuel to the one or more fuel combustion elements of the ammonia cracking reactor and using the one or more electrically powered heating elements to ignite the ammonia.
